(19) United States
(12) Patent Application Publication
(10) Pub. No.: US 2025/0296393 A1
(43) Pub. Date: Sep. 25, 2025

(54) METHOD FOR DETECTING A FOREIGN OBJECT UNDER A MOTOR VEHICLE

(71) Applicant: Continental Automotive Technologies GmbH, Hannover (DE)

(72) Inventors: Rachid BENBOUHOUT, Toulouse (FR); Jean-Christophe BOUTHINON, Toulouse (FR); Clément FERRY, Toulouse (FR)

(73) Assignee: Continental Automotive Technologies GmbH, Hannover (DE)

(21) Appl. No.: 19/050,305

(22) Filed: Feb. 11, 2025

(30) Foreign Application Priority Data
Mar. 19, 2024 (FR) FR2402710

(51) Int. Cl. B60C 23/04

(52) U.S. Cl. CPC B60C 23/0474; B60C 23/0433

(57) ABSTRACT

A method for detecting a foreign object under a vehicle fitted with a tire pressure monitoring system including at least two wheel units and a central unit including a communication device for communicating with each of the wheel units. The method includes a sounding step including a transmission phase which consists in transmitting at least one sounding signal from the first wheel unit to the second wheel unit across a transmission channel, and an analysis step which consists in comparing and in measuring differences in properties between the sounding signal received by the second wheel unit and a previously defined reference signal, and in determining whether the measured differences are characteristic of the presence of a foreign object present on the transmission channel taken by the sounding signal.

### CROSS REFERENCE TO RELATED APPLICATIONS

This application claims priority to French Application No. 2402710, filed Mar. 19, 2024, the contents of such application being incorporated by reference herein.

### FIELD OF THE INVENTION

The present patent application relates to a method for detecting a foreign object under a motor vehicle which is fitted with a tire pressure monitoring system.

### BACKGROUND OF THE INVENTION

For safety purposes, it is known to fit a motor vehicle with a monitoring system known by the abbreviation “TPMS” (Tire Pressure Monitoring System).

Such a monitoring system, which is, for example, described in the document FR3045498, incorporated herein by reference, generally comprises a central processing unit mounted on the vehicle and wheel units which are each fitted to an associated wheel of the vehicle.

The central unit comprises an electronic computer known by the abbreviation “ECU” (Electronic Control Unit).

The central unit of the vehicle is also fitted with a radio receiver designed to communicate with each wheel unit.

Each wheel unit is responsible for regularly acquiring physical quantities representative of operating parameters of the associated wheel, in particular for detecting an anomaly in the associated wheel.

Each wheel unit also transmits, to the central unit of the vehicle, messages comprising data relating to pressure, temperature and acceleration of the associated wheel, as well as an identification code of the transmitting wheel unit.

To this end, each wheel unit comprises a sensor for the inflation pressure of the tire, a temperature sensor, an accelerometer and a radio transmitter.

Furthermore, each wheel unit is fitted with a battery for power supply and with a microcontroller comprising a memory for storing data and a microprocessor.

Upon reception of these data by the central unit of the vehicle, in the event of a large difference in pressure in relation to the pressure recommended by the constructor, the TPMS system will inform the driver of the vehicle about an under-inflation in one of the wheels, via a warning message displayed on the dashboard of the vehicle for example.

A technical problem which still remains is detecting the presence of a foreign object present under the motor vehicle.

The foreign object is, for example, a living being, and more particularly an animal, which slides itself under the vehicle before or after the driver gets behind the steering wheel.

However, when starting-up the motor vehicle, the driver is not able to know whether there is a foreign object under the car.

Even if a visual check is made by the driver, this is not sufficient because there is a delay time between the moment at which the check is made and the moment at which the vehicle is started up, a time during which an animal may place itself under the vehicle.

Likewise, with regard to electric motor vehicles which are fitted with a battery recharged by induction, it is sought to avoid the presence of a foreign object under the vehicle so as to avoid harming this object if it is a living being.

Specifically, exposure to electromagnetic fields may have undesirable biological effects on living beings.

It is also sought to avoid the presence of a foreign object which is arranged under the electric vehicle and which is interposed between the induction charger and the vehicle so as to avoid disturbing the inductive recharging of the vehicle.

### SUMMARY OF THE INVENTION

An aspect of the present invention is to solve the problem of detecting the presence of a foreign object under a motor vehicle, in particular at the moment the vehicle is started up or at the moment the vehicle is inductively charged.

This aspect, and others which will become apparent from reading the following description, is achieved by a method for detecting a foreign object under a motor vehicle which is fitted with a tire pressure monitoring system, said system comprising at least:
a first wheel unit which is fitted to a first wheel of the motor vehicle and which comprises a first radio communication device comprising a transmitter and a receiver,
a second wheel unit which is fitted to a second wheel of the motor vehicle and which comprises a second communication device comprising a transmitter and a radio receiver, and
a central unit which comprises a computer and a communication device which is designed to communicate with each of said wheel units,
said method comprises at least:
a sounding step which successively comprises a transmission phase which consists in transmitting at least one sounding signal from the first wheel unit to the second wheel unit across a transmission channel which extends between the first wheel unit and the second wheel unit, then a phase of said sounding signal being received by the second wheel unit, and
an analysis step which consists in comparing and in measuring differences in properties between said sounding signal received by the second wheel unit and a previously defined reference signal, and in determining whether said measured differences are characteristic of the presence of a foreign object present on said transmission channel taken by said sounding signal.

Thus, an aspect of the present invention makes it possible to detect a foreign object present under the vehicle without having to go under the vehicle to check visually.

According to other optional features of an aspect of the invention, taken alone or in combination:
the properties measured during the analysis step relate to variation in power as a function of the frequency of the sounding signal;
the properties measured during the analysis step relate to variation in phase as a function of the frequency of the sounding signal;
the method comprises a step of determining the reference signal which is performed at least once before the sounding step and which successively comprises a transmission phase which consists in transmitting the sounding signal from the first wheel unit to the second wheel unit across said transmission channel, then a phase of receiving and storing the sounding signal received by the second wheel unit as being said reference signal;
the communication devices of each wheel unit and of the central unit operate according to the Bluetooth® standard. Specifically, the Bluetooth® standard permits bidirectional exchange between two peripherals;
in a minimal exemplary embodiment of the invention, the first wheel unit and the second wheel unit are arranged diagonally one another on the motor vehicle such that the transmission channel which separates them passes through the center of the vehicle;
the motor vehicle comprises four wheel units which are each fitted to one wheel of the vehicle, the transmission phase of the sounding step consisting in transmitting at least one sounding signal from each wheel unit to each of the three other wheel units, and the analysis step consisting in comparing and in measuring differences in properties between the sounding signal received by each wheel unit and a previously defined associated reference signal, and in determining whether said measured differences are characteristic of the presence of a foreign object present on the transmission channel taken by the sounding signal in question;
the method is executed by the motor vehicle when a start-up procedure of said vehicle is detected;
said motor vehicle is an electric motor vehicle powered by a battery, said method being executed when an inductive charging procedure of the battery is detected.

An aspect of the invention also relates to a motor vehicle which comprises at least a central unit and two wheel units which are suitably programmed to implement the method described above.

### BRIEF DESCRIPTION OF THE DRAWINGS

Other features, aims and advantages of aspects of the invention will become apparent upon reading the following detailed description, for the understanding of which reference will be made to the appended drawings, in which:

FIG. 1 is a schematic top view of a motor vehicle fitted with a central unit and four wheel units which are suitably programmed to implement the method according to an aspect of the invention;

FIG. 2 is a graph, with the abscissa axis showing the communication channels graduated in megahertz (MHz) and the ordinate axis graduated in decibel (dB), representative of the variation in power as a function of the frequency of the reference signal received by the second wheel unit and transmitted by the first wheel unit;

FIG. 3 is a graph similar to that of FIG. 2, representative of the variation in power as a function of the frequency of the sounding signal received by the second wheel unit and transmitted by the first wheel unit;

FIG. 4 is a graph, with the abscissa axis showing the communication channels graduated in megahertz (MHz) and the ordinate axis graduated in angle degrees) (°), representative of the variation in phase as a function of the frequency of the reference signal received by the second wheel unit and transmitted by the first wheel unit;

FIG. 5 is a graph similar to that of FIG. 4, representative of the variation in phase as a function of the frequency of the sounding signal received by the second wheel unit and transmitted by the first wheel unit;

FIG. 6 is a flowchart which illustrates the sequence of the steps of the method according to an aspect of the invention.

In all of these figures, identical or similar elements are denoted by identical or similar reference signs.

### DETAILED DESCRIPTION OF EXEMPLARY EMBODIMENTS

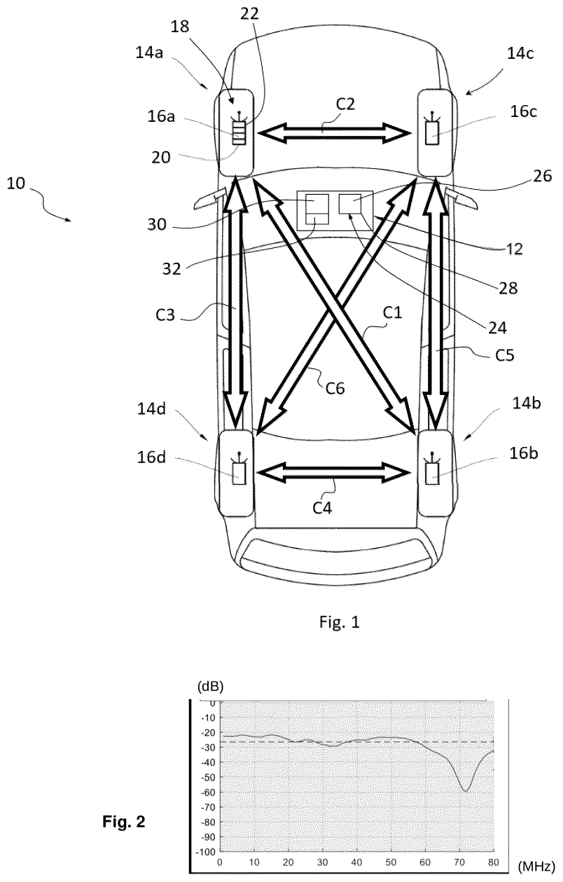

FIG. 1 schematically shows a motor vehicle 10 according to an aspect of the invention, which comprises a central unit 12 and four wheels 14a, 14b, 14c, 14d which are each fitted with a respective wheel unit 16a, 16b, 16c, 16d.

In order not to weigh down the description, only the first wheel unit 16a is described below, with the four wheel units 16a, 16b, 16c, 16d having a similar design and operation.

The wheel unit 16a belongs to a tire pressure monitoring system known by the abbreviation “TPMS”.

The wheel unit 16a comprises a casing which encloses a microcontroller fitted with a processor, a battery, a memory and a set of sensors dedicated to measuring operating parameters of the wheel unit 16a.

This set of sensors comprises, for example, a temperature sensor and a pressure sensor able to measure the inflation pressure of the tire of the associated wheel 14a.

The measurements taken by the sensors may be transmitted to the central unit 12 of the motor vehicle 10.

For this purpose, the wheel unit 16a comprises a radio communication device 18 which comprises a transmitter 20 and a receiver 22.

Likewise, the central unit 12 comprises a radio communication device 24 which is designed to communicate with each of the wheel units 16a, 16b, 16c, 16d and which comprises a transmitter 26 and a receiver 28.

According to one exemplary embodiment, the communication device 18 of each wheel unit 16a, 16b, 16c, 16d and the communication device 24 of the central unit 12 operate according to the Bluetooth® standard which permits short-distance bidirectional data exchange using radio waves.

In addition, the central unit 12 of the motor vehicle 10 comprises an electronic computer 30 and a memory 32.

In this exemplary embodiment of the invention, the motor vehicle 10 is an electric motor vehicle powered by a battery (not shown).

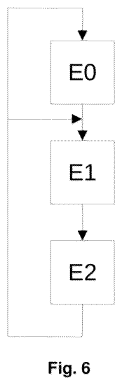

An aspect of the invention relates to a method for detecting a foreign object located under the motor vehicle 10, of which the sequence of steps is illustrated in FIG. 6.

“Foreign object” is understood to mean both a living being, such as an animal, and an inanimate object.

The method according to an aspect of the invention comprises a first sounding step E1 which successively comprises a transmission phase followed by a reception phase.

The transmission phase consists in transmitting a sounding signal successively from each wheel unit 16a, 16b, 16c, 16d to each of the three other wheel units 16a, 16b, 16c, 16d.

The reception phase consists in each of the three other wheel units 16a, 16b, 16c, 16d receiving the sounding signal transmitted successively by each wheel unit 16a, 16b, 16c, 16d.

The wheel units 16a, 16b, 16c, 16d are connected two by two by a transmission channel across which the signals are transmitted.

The expression “transmission channel” refers to the route by which data are transmitted between a transmitter and a receiver.

In the context of communication of the Bluetooth® type according to an aspect of the invention, the transmission channel is the path by which the radio signals pass between the connected wheel units 16a, 16b, 16c, 16d.

As can be seen in FIG. 1, a first channel C1 extends between the first wheel unit 16a and the second wheel unit 16b, a second channel C2 extends between the first wheel unit 16a and the third wheel unit 16c, a third channel C3 extends between the first wheel unit 16a and the fourth wheel unit 16d, a fourth channel C4 extends between the second wheel unit 16b and the fourth wheel unit 16d, a fifth channel C5 extends between the second wheel unit 16b and the third wheel unit 16c, and a sixth channel C6 extends between the third wheel unit 16c and the fourth wheel unit 16d.

According to one preferred exemplary embodiment of the invention, the first sounding step E1 consists in executing a “channel sounding” function which is specific to Bluetooth® technology.

The “channel sounding” function is generally implemented to measure the quality and the conditions of the transmission channel, in particular interference, noise and other parameters.

The first sounding step E1 is followed by a second analysis step E2 which consists in comparing and in measuring differences in properties between the sounding signal received by each wheel unit 16a, 16b, 16c, 16d and a previously defined reference signal associated with each receiving wheel unit 16a, 16b, 16c, 16d.

This second analysis step E2 is performed by the computer 30 of the central unit 12.

For this purpose, the sounding signal to be analyzed is transmitted by radio communication to the central unit 12 which analyzes said sounding signal with the corresponding reference signal which is stored in the memory 32 of the central unit 12.

For example, the sounding signal received by the second wheel unit 16b and sent from the first wheel unit 16a across the first transmission channel C1 is compared with the reference signal which is associated with this pair of wheel units 16a, 16b and the associated channel C1.

Each reference signal is a signal which is characteristic of an “empty” transmission between the transmitter of a wheel unit 16a, 16b, 16c, 16d and the receiver of another wheel unit 16a, 16b, 16c, 16d, that is to say when the transmission channel taken by the signal is not disturbed by the presence of a foreign object.

Specifically, the transmission channel may be affected by various factors such as radioelectric interference, electromagnetic noise and physical obstacles.

The analysis step E2 makes it possible to determine whether the measured differences between the sounding signal received by the relevant wheel unit 16a, 16b, 16c, 16d and the associated reference signal are characteristic of the presence of a foreign object present on the transmission channel taken.

According to one exemplary embodiment of the invention, the properties measured during the analysis step E2 relate to variation in power as a function of the frequency of the sounding signal upon reception.

By way of example, FIG. 2 shows a graph representative of the variation in power as a function of the frequency of the reference signal received by the second wheel unit 16b and transmitted by the first wheel unit 16a.

FIG. 3 also shows a graph similar to that of FIG. 2, representative of the variation in power as a function of the frequency of the sounding signal received by the second wheel unit 16b and transmitted by the first wheel unit 16a.

Substantial differences between the graph of FIG. 2 and that of FIG. 3 can be observed, differences which are characteristic of the presence of a foreign object present on the transmission channel C1 taken.

The properties measured during the analysis step E2 also relate to variation in phase as a function of the frequency of the sounding signal upon reception; this is referred to as phase signature.

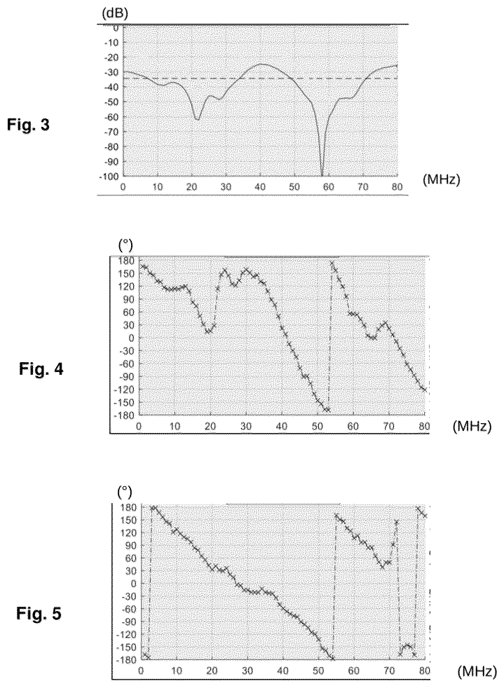

By way of example, FIG. 4 shows a graph representative of the variation in phase as a function of the frequency of the reference signal received by the second wheel unit 16b and transmitted by the first wheel unit 16a.

In other words, the graph of FIG. 4 shows the phase signature of the reference signal received by the second wheel unit 16b.

In this exemplary embodiment, the Bluetooth® communication uses a frequency band of 80 megahertz comprised between 2402 and 2480 megahertz, i.e. forty channels spaced apart by two megahertz.

In a non-limiting manner, it should be noted that the communication devices 18, 24 may operate according to other technologies which make it possible to have information about the transmission channel in terms of amplitude and phase, for example Wifi or Ultra Wide Band UWB.

FIG. 5 also shows a graph similar to that of FIG. 4, representative of the variation in phase as a function of the frequency of the sounding signal received by the second wheel unit 16b and transmitted by the first wheel unit 16a.

Substantial differences between the graph of FIG. 4 and that of FIG. 5 can be observed, differences which are characteristic of the presence of a foreign object present on the transmission channel C1 taken.

Preferably, the method according to an aspect of the invention is executed by the motor vehicle 10 when a start-up procedure of the vehicle is detected.

Thus, if a foreign object is detected during the analysis step E2, the start-up of the motor vehicle 10 is prevented and/or a warning message is displayed on the dashboard of the vehicle.

Likewise, the method according to an aspect of the invention may be executed by the motor vehicle 10 when an inductive charging procedure of the battery of the vehicle is detected, or during the inductive charging procedure.

If a foreign object is detected during the analysis step E2, the recharging of the motor vehicle 10 is prevented or suspended, and/or a warning message is displayed on the dashboard of the vehicle.

Finally, the method according to an aspect of the invention comprises a step of determining the reference signal E0, which is performed before the sounding step E1.

For example, the step of determining the reference signal E0 is performed in the factory when the motor vehicle 10 is fitted with its four wheel units 16a, 16b, 16c, 16d.

However, the step of determining the reference signal E0 may be performed during the life of the motor vehicle 10, for example when one or more wheel units 16a, 16b, 16c, 16d are replaced.

The step of determining the reference signal E0 comprises a transmission phase which consists in transmitting the sounding signal successively from each wheel unit 16a, 16b, 16c, 16d to each of the three other wheel units 16a, 16b, 16c, 16d.

The step of determining the reference signal E0 also comprises a reception phase which consists in each of the three other wheel units 16a, 16b, 16c, 16d receiving the sounding signal transmitted successively by each wheel unit 16a, 16b, 16c, 16d.

This reception phase is followed by a phase of storing the received sounding signal as being the reference signal, and of associating the reference signal with the pair of wheel units in question.

Of course, the step of determining the reference signal E0 is carried out when no foreign object is present under the motor vehicle 10.

Thus, the method according to an aspect of the invention makes it possible to detect the presence of a foreign object present under the motor vehicle 10 by scanning a wide area comprised between the four wheel units 16a, 16b, 16c, 16d.

In a non-limiting manner, in a minimal configuration of the method according to an aspect of the invention, the method is executed between only two wheel units 16a, 16b which are arranged diagonally one another such that the transmission channel C1 which separates them passes through the center of the motor vehicle 10.

Naturally, the invention is described in the preceding text by way of example. It is understood that a person skilled in the art is able to produce various variant embodiments of the invention without thereby departing from the scope of the invention.

1. A method for detecting a foreign object under a motor vehicle which is fitted with a tire pressure monitoring system, said system comprising at least:
a first wheel unit which is fitted to a first wheel of the motor vehicle and which comprises a first radio communication device comprising a transmitter and a receiver,
a second wheel unit which is fitted to a second wheel of the motor vehicle and which comprises a second communication device comprising a transmitter and a radio receiver, and
a central unit which comprises a computer and a communication device which is designed to communicate with each of said wheel units,
said method comprises at least:
a sounding step which successively comprises a transmission phase which consists in transmitting at least one sounding signal from the first wheel unit to the second wheel unit across a transmission channel which extends between the first wheel unit and the second wheel unit, then a phase of said sounding signal being received by the second wheel unit, and
an analysis step which consists in comparing and in measuring differences in properties between said sounding signal received by the second wheel unit and a previously defined reference signal, and in determining whether said measured differences are characteristic of the presence of a foreign object present on said transmission channel taken by said sounding signal.

2. The method for detecting a foreign object as claimed in claim 1, wherein the properties measured during the analysis step relate to variation in power as a function of the frequency of the sounding signal.

3. The method for detecting a foreign object as claimed in claim 1, wherein the properties measured during the analysis step relate to variation in phase as a function of the frequency of the sounding signal.

4. The method for detecting a foreign object as claimed in claim 1, further comprising a step of determining the reference signal which is performed at least once before the sounding step and which successively comprises a transmission phase which consists in transmitting the sounding signal from the first wheel unit to the second wheel unit across said transmission channel, then a phase of receiving and storing the sounding signal received by the second wheel unit as being said reference signal.

5. The method for detecting a foreign object as claimed in claim 1, wherein the communication devices of each wheel unit and of the central unit operate according to the Bluetooth® standard.

6. The method for detecting a foreign object as claimed in claim 1, wherein the first wheel unit and the second wheel unit are arranged diagonally one another on the motor vehicle such that the transmission channel which separates them passes through the center of the vehicle.

7. The method for detecting a foreign object as claimed in claim 1, wherein the motor vehicle comprises four wheel units which are each fitted to one wheel of the vehicle, the transmission phase of the sounding step consisting in transmitting at least one sounding signal from each wheel unit to each of the three other wheel units, and the analysis step consisting in comparing and in measuring differences in properties between the sounding signal received by each wheel unit and a previously defined associated reference signal, and in determining whether said measured differences are characteristic of the presence of a foreign object present on the transmission channel taken by the sounding signal in question.

8. The method for detecting a foreign object as claimed in claim 1, wherein the method is executed by the motor vehicle when a start-up procedure of said vehicle is detected.

9. The method for detecting a foreign object as claimed in claim 1, wherein said motor vehicle is an electric motor vehicle powered by a battery, said method being executed when an inductive charging procedure of the battery is detected.

10. A motor vehicle which comprises at least a central unit and two wheel units which are suitably programmed to implement the method as claimed in claim 1.
